(19) United States
(12) Patent Application Publication
(10) Pub. No.: US 2022/0092804 A1
(43) Pub. Date: Mar. 24, 2022

(54) THREE-DIMENSIONAL IMAGING AND SENSING USING A DYNAMIC VISION SENSOR AND PATTERN PROJECTION

(71) Applicant: PROPHESEE, Paris (FR)

(72) Inventors: Guillaume CHICAN, Villemomble (FR); Manuele BRAMBILLA, Paris (FR); Xavier LAGORCE, Saint-Maur-des-Fosses (FR)

(73) Assignee: PROPHESEE, Paris (FR)

(21) Appl. No.: 17/310,755

(22) PCT Filed: Feb. 21, 2020
(86) PCT No.: PCT/EP2020/054685

§ 371 Date: Aug. 20, 2021

Related U.S. Application Data
(60) Provisional application No. 62/809,557, filed on Feb. 22, 2019.
(60) Provisional application No. 62/810,926, filed on Feb. 26, 2019.
(60) Provisional application No. 62/965,149, filed on Jan. 23, 2020.

(51) Int. Cl. G06T 7/521; G01B 11/25; G06K 9/62; G01B 11/14

(52) U.S. Cl. CPC G06T 7/521; G01B 11/2513; G06T 2200/08; G01B 11/14; G06K 9/62

(57) ABSTRACT

In one implementation, a three-dimensional image sensing system is provided that includes at least one processor that detects, from an image sensor, one or more first events based on reflections caused by electromagnetic pulses associated with a plurality of projected line patterns and corresponding to one or more first pixels of the image sensor. The at least one processor also detects, from the image sensor, one or more second events based on the reflections and corresponding to one or more second pixels of the image sensor, identifies a line corresponding to the one or more second events and the one or more first events, calculates three-dimensional rays for the one or more first pixels and the one or more second pixels based on the identified line, and calculates three-dimensional image or more first pixels and the one or more second pixels based on the three-dimensional rays and a plane equation.

### TECHNICAL FIELD

The present disclosure generally relates to the field of image sensing and processing. More specifically, and without limitation, the disclosure relates to computer-implemented systems and methods for three-dimensional imaging and sensing. The disclosure additionally relates to three-dimensional image sensing using event-based image sensors. The image sensors and techniques disclosed herein may be used in various applications and vision systems, such as security systems, autonomous vehicles, and other systems that benefit from rapid and efficient three-dimensional sensing and detection.

### BACKGROUND

Extant three-dimensional image sensing systems include those that produce depth maps of scenes. Such sensing systems have drawbacks, including low spatial and/or temporal resolution. Such three-dimensional image sensing systems also suffer from other drawbacks, including being too computationally expensive and/or having other processing limitations.

For example, time-of-flight camera systems generally measure depth directly. In such cameras, a modulated signal is emitted using a laser projector, and the distance is estimated by measuring the time shift between the emitted signal and its reflection from objects in the observed scene. Depending on the implementation, time-of-flight systems usually generate up to 60 depth images per second. However, most time-of-flight cameras have low spatial resolutions (e.g., 100,000 pixels or lower). Moreover, the use of a laser projector does not allow for time-of-flight cameras to be used in low-power applications while retaining a high range and a high spatial resolution.

Stereo cameras are based on the idea that it is possible to match points from one view to points in another view. Using the relative position of the two cameras, stereo cameras estimate the three-dimensional position of points in space. However, stereo cameras typically have limited image density, as only detected points from textured environments can be measured. Moreover, stereo cameras are computationally expensive, therefore suffering from low temporal resolution as well as being limited in use for low-power applications.

Structured light cameras function similarly to stereo cameras but use a pattern projector in lieu of a second camera. By defining the projected pattern, a structured light camera may perform triangulation without using a second camera. Structured light solutions usually have higher spatial resolutions (e.g., up to 300,000 pixels). However, structured light cameras are computationally expensive and/or generally suffer from low temporal resolution (e.g., around 30 fps). The temporal resolution may be increased but at the expense of spatial resolution. Similar to time-of-flight cameras, structured light cameras are limited in use (e.g., limited in range and spatial resolution) for low-power applications.

Active stereo image sensors combine passive stereo and structured light techniques. In particular, a projector projects a pattern, which may be recognized by two cameras. Matching the pattern in both images allows estimation of depth at matching points by triangulation. Active stereo can revert to passive stereo in situations where the pattern cannot be decoded easily, such as an outdoor environment, in a long-range mode, or the like. As a result, active stereo, like structured light techniques and stereo techniques, suffer from low temporal resolution as well as being limited in use for low-power applications.

Some structured light systems integrating an event-based camera have been developed. In these systems, a laser beam projects a single blinking dot at a given frequency. Cameras may then detect the change of contrast caused by the blinking dot, and event-based cameras can detect such changes with a very high temporal accuracy. Detecting the changes of contrast at the given frequency of the laser allows the system to discriminate events produced by the blinking dot from other events in the scene. In some implementations, the projected dot is detected by two cameras, and the depth at the point corresponding to the blinking dot is reconstructed using triangulation. In other systems developed by the applicant, Prophesee, a projector may encode patterns or symbols in dot pulses projected into the scene. An event-based image sensor may then detect the same pattern or symbol reflected from the scene and triangulate using the location from which the pattern was projected and the location at which the pattern was detected to determine a depth at a corresponding point in the scene.

When only projecting one dot at a time at a random position in the image, the temporal resolution directly decreases with the number of used dot locations. Moreover, even if a system was implemented to project a plurality of dots simultaneously, it may be necessary for the scene to be stable until the entire temporal code has been decoded. Therefore, this approach may not be able to reconstruct dynamic scenes.

### SUMMARY

Embodiments of the present disclosure provide computer-implemented systems and methods that address the aforementioned drawbacks. In this disclosure, systems and methods for three-dimensional image sensing are provided that have advantages such as being computationally efficient as well as compatible with dynamic scenes. With the present embodiments, the generated data may include depth information, allowing for three-dimensional reconstruction of a scene, e.g., as a point cloud. Additionally, embodiments of the present disclosure may be used in low-power applications, such as augmented reality, robotics, or the like, while still providing data of comparable, or even higher, quality than other higher-power solutions.

Embodiments of the present disclosure may project lines comprising patterns of electromagnetic pulses and receive reflections of those patterns at an image sensor. In some embodiments, a projector (e.g., a laser projector) may deform the projected line into a curve. Accordingly, as used throughout, a “line” may refer to a geometric line or to a curved line. Moreover, the line may comprise a plurality of dots with varying intensity, such that the line may comprise a dotted line or the like. The patterns may be indexed to spatial coordinates of the projector, and the image sensor may index the received reflections by location(s) of the pixel(s) receiving the reflections. Accordingly, embodiments of the present disclosure may triangulate depths based on the spatial coordinates of the projector and the pixel(s).

By using lines, embodiments of the present disclosure may be faster and increase density compared with dot-based approaches. Moreover, lines may require fewer control signals for a projector as compared with dots, reducing power consumption.

To account for dynamic scenes, embodiments of the present disclosure may use state machines to identify a reflected curve corresponding to a projected line. Additionally, in some embodiments, the state machines may further track received patterns temporally that move across pixels of the image sensor. Thus, a depth may be calculated even if different pixels receive different portions of a pattern. Accordingly, embodiments of the present discourse may solve technical problems presented by extant technologies, as explained above.

Embodiments of the present disclosure may also provide for higher temporal resolution. For example, latency is kept low by using triangulation of known patterns (e.g., stored patterns and/or patterns provided from a projector of the patterns to a processor performing the triangulation) rather than matching points in captured images. Moreover, the use of state machines can improve accuracy without sacrificing latency. As compared with a brute laser line sweep, embodiments of the present disclosure may reduce latency and sensitivity to jitter. Moreover, embodiments of the present disclosure may increase accuracy in distinguishing between environmental light and reflections from the projected lines.

In some embodiments, the temporal resolution may be further increased by using an event-based image sensor. Such a sensor may capture events in a scene based on changes in illuminations at pixels exceeding a threshold. Asynchronous sensors can detect patterns projected into the scene while reducing the amount of data generated. Accordingly, the temporal resolution may be increased.

Moreover, in some embodiments, the reduction in data due to the use of event-based image sensors may allow for increasing the rate of light sampling at each pixel, e.g., from 30 times per second or 60 times per second (i.e., frame rates of typical CMOS image sensors) to higher rates such as 1,000 times per second, 10,000 times per second and more. The higher rate of light sampling increases the accuracy of the pattern detection compared to extant techniques.

In one embodiment, a system for detecting three-dimensional images may comprise a projector configured to project a plurality of lines comprising electromagnetic pulses onto a scene; an image sensor comprising a plurality of pixels and configured to detect reflections in the scene caused by the projected plurality of lines; and at least one processor. The at least one processor may be configured to: detect one or more first events from the image sensor based on the detected reflections and corresponding to one or more first pixels of the image sensor; detect one or more second events from the image sensor based on the detected reflections and corresponding to one or more second pixels of the image sensor; and identify a projected line corresponding to the one or more second events and the one or more first events. Further, in some embodiments, the at least one processor may be configured to calculate three-dimensional image points based on the identified line. Still further, the at least one processor may be configured to calculate three-dimensional rays for the one or more first pixels and the one or more second pixels based on the identified line and calculate the three-dimensional image points based on the three-dimensional rays and a plane equation associated with the identified line. Additionally, or alternatively, the three-dimensional image points may be calculated using a quadratic surface equation.

In such embodiments, the at least one processor may further be configured to determine a plurality of patterns associated with the plurality of lines. Further, the one or more first events may correspond to a start of the plurality of patterns associated with the plurality of lines. Moreover, the one or more second events may correspond to an end of the plurality of patterns associated with the plurality of lines.

In any of these embodiments, the projector may be configured to project one or more dots of each line simultaneously. Alternatively, the projector may be configured to project one or more dots of each line sequentially.

In any of these embodiments, the plurality of patterns may comprise at least two different pulse lengths separated by a length in time. Additionally, or alternatively, the plurality of patterns may comprise a plurality of pulses separated by different lengths of time. Additionally, or alternatively, the plurality of patterns may comprise pulses having at least one of selected frequencies, phase shifts, or duty cycles used to encode symbols.

In any of these embodiments, the projector may be configured to project the plurality of lines to a plurality of spatial locations in the scene. Moreover, at least one of the spatial locations may correspond to a first pattern, and at least one other of the spatial locations may correspond to a second pattern.

In any of these embodiments, the projector may be configured to project one or more dots of the plurality of lines at a plurality of different projection times. Moreover, at least one of the projection times may correspond to at least one of the one or more first events, and at least one other of the projection times may correspond to at least one of the one or more second events.

In any of these embodiments, each pixel of the image sensor may comprise a detector that is electrically connected to at least one first photosensitive element and configured to generate a trigger signal when an analog signal that is a function of brightness of light impinging on the at least one first photosensitive element matches a condition. In some embodiments, at least one second photosensitive element may be provided that is configured to output a signal that is a function of brightness of light impinging on the at least one second photosensitive element in response to the trigger signal. Still further, the at least one first photosensitive element may comprise the at least one second photosensitive element. In any of these embodiments, the at least one processor may receive one or more first signals from at least one of the first photosensitive element and the second photosensitive element, wherein the one or more first signals may have positive polarity when the condition is an increasing condition and negative polarity when the condition is a decreasing condition. Accordingly, the at least one processor may be further configured to decode polarities of the one or more first signals to obtain the one or more first events or the one or more second events. Additionally, or alternatively, the at least one processor may be further configured to discard any of the one or more first signals that are separated by an amount of time larger than a threshold and/or to discard any of the one or more first signals associated with an optical bandwidth not within a predetermined range.

In any of these embodiments, the at least one first photosensitive element may comprise the at least one second photosensitive element. Consistent with some embodiments, an exposure measurement circuit may be removed such that only events from a condition detector are output by the image sensor. Accordingly, the first and second photosensitive elements may comprise a single element used only by a condition detector.

Alternatively, the at least one first photosensitive element and the at least one second photosensitive element may be, at least in part, distinct elements.

In any of these embodiments, the system may further comprise an optical filter configured to block any reflections associated with a wavelength not within a predetermined range.

In any of these embodiments, the plurality of patterns may comprise a set of unique symbols encoded in electromagnetic pulses. Alternatively, the plurality of patterns may comprise a set of quasi-unique symbols encoded in electromagnetic pulses. For example, the symbols may be unique within a geometrically defined space. In such embodiments, the geometrically defined space may comprise one of the plurality of lines.

In any of these embodiments, the at least one processor may be configured to determine the plane equation based on which pattern of the plurality of patterns is represented by the one or more first events and the one or more second events. Additionally, or alternatively, the at least one processor may be configured to determine a plurality of plane equations associated with the plurality of lines and select the line associated with the one or more first events and the one or more second events to determine the associated plane equation of the plurality of plane equations.

In any of these embodiments, the at least one processor may be configured to calculate the three-dimensional image points based on an intersection of the plurality of rays and the associated plane equation. In such embodiments, the plurality of rays may originate from the sensor and represent a set of three-dimensional points in the scene that correspond to the one or more first pixels and the one or more second pixels.

For example, the projection of a straight line into three-dimensional (3D) space corresponds to a 3D plane, whose corresponding plane equation may comprise a′X+b′Y+c′Z+d′=0 (equation 1), where X, Y, and Z are coordinates of points lying on the plane in 3D space, and a′, b′, c′, and d′ are constants defining the plane. The origin is the camera optical center at position (0, 0, 0). For a pixel (i, j) on the sensor, located in the i'th pixel row and j'th pixel column, the pixel position in 3D space can be identified using sensor calibration parameters, an (x, y, f), where f is the focal length according to a pin-hole camera model. All 3D points projecting to (i, j) on the sensor are on the 3D ray which passes through (x, y, f) and the optical center (0, 0, 0). For all 3D points on the ray, there exists a scalar constant A as defined by the following (equation 2):

$$( \begin{matrix}X \\ Y \\ Z\end{matrix} ) = λ ( \begin{matrix}x \\ y \\ f\end{matrix} )$$

To triangulate the 3D point at the intersection of the 3D plane from the projector and the 3D ray from the camera, equation 2 can be injected into equation 1 as:

a′λx+b′λy+c′λf+d′=0

which yields

$$λ = \frac{- {d}^{′}}{{a}^{′} x + {b}^{′} y + {c}^{′} f}$$

$$and \\ ( \begin{matrix}X \\ Y \\ Z\end{matrix} ) = \frac{- {d}^{′}}{{a}^{′} x + {b}^{′} y + {c}^{′} f} ( \begin{matrix}x \\ y \\ f\end{matrix} )$$

In some embodiments, the projection is a curved line into 3D space. This is no longer a plane, but a curved surface. Therefore, another triangulation operation may be used as opposed to one based on the above-described plane equation. For example, a quadratic surface model may be used, of the general equation:

$$( X Y Z ) Q ( \begin{matrix}X \\ Y \\ Z\end{matrix} ) + P ( \begin{matrix}X \\ Y \\ Z\end{matrix} ) + R = 0$$

where Q is a 3×3 matrix, P is a three-dimensional row vector and R is a scalar constant. Triangulating a 3D point at the intersection of a 3D ray from the camera and the 3D surface is possible by injecting equation 2 into the quadratic surface equation and solving for A.

In any of these embodiments, the at least one processor may be configured to initialize one or more state machines based on the one or more first events. Still further, the at least one processor may be configured to store, in a memory or storage device, finalized state machines comprising the one or more initialized state machines and candidates for connecting the one or more first events to the one or more second events. Accordingly, the at least one processor may be further configured to use the stored state machines in determining candidates for subsequent events.

In any of these embodiments, determining candidates for connecting the one or more second events to the one or more first events may use the plurality of patterns and the one or more stored state machines. Additionally, or alternatively, the one or more second events may be timestamped after the one or more first events such that the candidates connect the one or more first events to the one or more second events temporally.

In any of these embodiments, detecting the one or more first events may comprise receiving one or more first signals from the image sensor and detecting the one or more first events based on the one or more first signals. Additionally, or alternatively, detecting the one or more first events may comprise receiving one or more first signals from the image sensor, wherein the one or more first signals encode the one or more first events.

In one embodiment, an imaging system may comprise a plurality of pixels and at least one processor. Each pixel may comprise a first photosensitive element, a detector that is electrically connected to the first photosensitive element and configured to generate a trigger signal when an analog signal that is a function of brightness of light impinging on the first photosensitive element matches a condition. Optionally, one or more second photosensitive elements may also be provided that are configured to output a signal that is a function of brightness of light impinging on the one or more second photosensitive elements. In some embodiments, the at least one processor may be configured to detect one or more first events from the one or more second photosensitive elements based on detected reflections from a scene and in response to trigger signals from the detector and corresponding to one or more first pixels of the plurality of pixels; initialize one or more state machines based on the one or more first events; detect one or more second events from the one or more second photosensitive elements based on detected reflections from the scene and in response to trigger signals from the detector and corresponding to one or more second pixels of the plurality of pixels based on the received second signals; determine one or more candidates for connecting the one or more second events to the one or more first events; and using the one or more candidates, identify a projected line corresponding to the one or more second events and the one or more first events. Further, in some embodiments, the at least one processor may be configured to calculate three-dimensional rays for the one or more first pixels and the one or more second pixels based on the identified line; and calculate three-dimensional image points for the one or more first pixels and the one or more second pixels based on the three-dimensional rays. In some embodiments, the three-dimensional image points may be additionally calculated based on a plane equation associated with a line projected onto the scene corresponding to the identified line. In other embodiments, a triangulation operation that is based on a curved line and the aforementioned quadratic surface equation may be utilized.

In such embodiments, the at least one processor may be further configured to determine a plurality of patterns associated with a plurality of lines comprising electromagnetic pulses projected onto a scene, wherein determining the plurality of patterns may comprise receiving digital signals defining amplitudes separated by time intervals. For example, the digital signals defining amplitudes separated by time intervals may be received from a controller associated with a projector configured to project a plurality of electromagnetic pulses according to the plurality of patterns. Additionally, or alternatively, the digital signals defining amplitudes separated by time intervals may be retrieved from at least one non-transitory memory storing patterns.

In any of the embodiments described above, the first photosensitive element may comprise the one or more second photosensitive elements. Further, in some embodiments, there are no second photosensitive elements.

In one embodiment, a method for detecting three-dimensional images may comprise determining a plurality of patterns corresponding to a plurality of lines comprising electromagnetic pulses emitted by a projector onto a scene; detecting, from an image sensor, one or more first events based on reflections caused by the plurality of electromagnetic pulses and corresponding to one or more first pixels of the image sensor; initializing one or more state machines based on the one or more first events; detecting, from the image sensor, one or more second events based on the reflections and corresponding to one or more second pixels of the image sensor; determining one or more candidates for connecting the one or more second events to the one or more first events; using the one or more candidates, identifying a projected line corresponding to the one or more second events and the one or more first events; calculating three-dimensional rays for the one or more first pixels and the one or more second pixels based on the identified line; and calculating three-dimensional image points for the one or more first pixels and the one or more second pixels based on the three-dimensional rays and a plane equation associated with one of the lines corresponding to the identified line.

In one embodiment, a system for detecting three-dimensional images may comprise a projector configured to project a plurality of lines comprising electromagnetic pulses onto a scene; an image sensor comprising a plurality of pixels and configured to detect reflections in the scene caused by the projected plurality of lines; and at least one processor. The at least one processor may be configured to: encode a plurality of symbols into a plurality of patterns associated with the plurality of lines, the plurality of symbols relating to at least one spatial property of the plurality of lines; command the projector to project the plurality of patterns onto the scene; detect one or more first events from the image sensor based on the detected reflections and corresponding to one or more first pixels of the image sensor; initialize one or more state machines based on the one or more first events; detect one or more second events from the image sensor based on the detected reflections and corresponding to one or more second pixels of the image sensor; determine one or more candidates for connecting the one or more second events to the one or more first events; using the one or more candidates and the one or more state machines, decode the one or more first events and the one or more second events to obtain the at least one spatial property; and calculate three-dimensional image points for the one or more first pixels and the one or more second pixels based on locations of the one or more first events and the one or more second events on the sensor and the at least one spatial property.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the disclosed embodiments.

### BRIEF DESCRIPTION OF THE DRAWINGS

The accompanying drawings, which comprise a part of this specification, illustrate various embodiments and, together with the description, serve to explain the principles and features of the disclosed embodiments. In the drawings:

FIG. 1A is a schematic representation of an exemplary Moore state machine, according to embodiments of the present disclosure.

FIG. 1B is a schematic representation of an exemplary Mealy state machine, according to embodiments of the present disclosure.

FIG. 2A is a schematic representation of an exemplary image sensor, according to embodiments of the present disclosure.

FIG. 2B is a schematic representation of an exemplary asynchronous image sensor, according to embodiments of the present disclosure.

FIG. 3A is a schematic representation of a system using a pattern projector with an image sensor, according to embodiments of the present disclosure.

FIG. 3B is a graphical representation of determining three-dimensional image points using an intersection of a ray and an associated plane equation, according to embodiments of the present disclosure.

FIG. 4A is a schematic representation of an example electromagnetic pattern transformed by state machines, according to embodiments of the present disclosure.

FIG. 4B is a graphical representation of identifying a curve using state machines, according to embodiments of the present disclosure.

FIG. 5A is a flowchart of an exemplary method for detecting three-dimensional images, according to embodiments of the present disclosure.

FIG. 5B is a flowchart of another exemplary method for detecting three-dimensional images, according to embodiments of the present disclosure.

FIG. 6 is a graphical illustration of an exemplary state machine decoding, according to embodiments of the present disclosure.

FIG. 7 is a flowchart of an exemplary method for connecting events from an image sensor into clusters, consistent with embodiments of the present disclosure.

FIG. 8 is a graphical illustration of an exemplary symbol encoding using detected amplitude changes, according to embodiments of the present disclosure.

FIG. 9 is a flowchart of an exemplary method for detecting event bursts, consistent with embodiments of the present disclosure.

### DETAILED DESCRIPTION

The disclosed embodiments relate to systems and methods for capturing three-dimensional images by sensing reflections of projected patterns of light, such as one or more line patterns. The disclosed embodiments also relate to techniques for using image sensors, such as synchronous or asynchronous image sensors, for three-dimensional imaging. Advantageously, the exemplary embodiments can provide fast and efficient three-dimensional image sensing. Embodiments of the present disclosure may be implemented and used in various applications and vision systems, such as autonomous vehicles, robotics, augmented reality, and other systems that benefit from rapid and efficient three-dimensional image detection.

Embodiments of the present disclosure may be implemented through any suitable combination of hardware, software, and/or firmware. Components and features of the present disclosure may be implemented with programmable instructions implemented by a hardware processor. In some embodiments, a non-transitory computer-readable storage medium including instructions is also provided, and the instructions may be executed by at least one processor for performing the operations and methods disclosed herein. Common forms of non-transitory media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, an EPROM, a FLASH-EPROM or any other flash memory, NVRAM, a cache, a register, any other memory chip or cartridge, and networked versions of the same. In some embodiments, systems consistent with the present disclosure may include one or more processors (CPUs), an input/output interface, a network interface, and/or a memory. In networked arrangements, one or more servers and/or databases may be provided that are in communication with the system.

Although embodiments of the present disclosure are described herein with general reference to an imaging sensor, it will be appreciated that such a system may part of a camera, a LIDAR, or another imaging system. Moreover, although some embodiments are described in combination with a projector (such as a laser projector), it will be appreciated that such components may be separate from the image sensors and/or processors described herein.

Embodiments of the present disclosure may use state machines to connect reflections along a curve that corresponds to a line projected into a scene. Additionally, or alternatively, embodiments of the present disclosure may use state machines to track reflections across one or more pixels of an image sensor. Accordingly, state machines may describe the transformation of projected lines of light patterns into the tracked reflections and thus allow for recreation of any dynamic portions of a scene as well as static portions. State machines consistent with the present disclosure may be implemented through any suitable combination of hardware, software, and/or firmware.

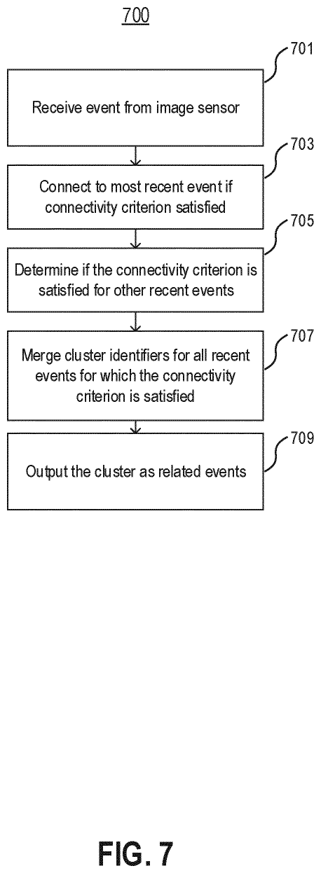

As used herein, a “pattern” may refer to any combination of light pulses having one or more characteristics. For example, a pattern may comprise at least two different amplitudes separated by a length of time, at least two different wavelengths separated by a length of time, at least two different pulse lengths separated by a length of time, a plurality of pulses separated by different lengths of time, or the like. Moreover, a pattern may have at least one of frequencies, phase shifts, or duty cycles used to encode symbols (e.g., as explained below with respect to the example embodiment of FIG. 7). Accordingly, a “pattern” need not be regular but may comprise an irregular combination of pulses forming a pattern.

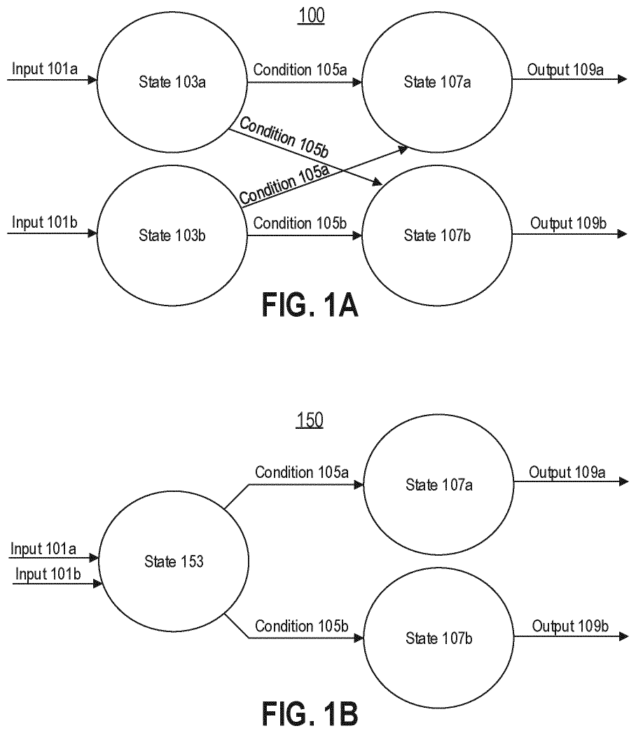

FIG. 1A is a schematic representation of an exemplary Moore state machine 100, consistent with embodiments of the present disclosure. In the example of FIG. 1A, one or more states (e.g., states 103a and 103b) may transform to different states (e.g., states 107a and 107b) depending on whether the input (e.g., inputs 101a and 101b) satisfy certain conditions (e.g., conditions 105a and 105b). Further states may test output from previous states against new conditions or may generate different outputs (e.g., outputs 109a and 109b).

FIG. 1B is a schematic representation of an exemplary Mealy state machine 150, consistent with embodiments of the present disclosure. Mealy state machine 150 of FIG. 1B is equivalent to Moore state machine 100 of FIG. 1A. Mealy state machine 150, unlike Moore state machine 100, may change states directly based on input to a state. Accordingly, states 103a and 103b of FIG. 1A may be replaced with state 153 of FIG. 1B.

State machines, such as those depicted in FIGS. 1A and 1B, may be used to describe any condition-based transformation of one state to another. Accordingly, embodiments of the present disclosure may search for state machines that transform a projected pattern of light, such as a line, into one or more states of an image sensor caused by a reflection from the projected pattern of light, such as an expected curve formed on the pixels of the image sensor. These state machines thus connect different portions of a reflection across pixels in order to reconstruct (and decode) the projected pattern. Additionally, the state machines may connect portions of a reflection across pixels if the reflection moves in time. Thus, the state machines may connect events temporally as well as spatially. Accordingly, embodiments of the present disclosure may identify the projected patterns even if there are physical dynamics in a scene (e.g., transversal movement by one or more objects in the scene, rotational movement by one or more objects in the scene, increases in illumination or reflectivity of one or more objects in the scene, or the like).

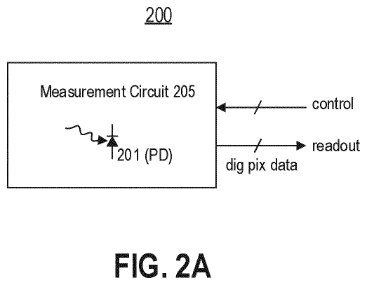

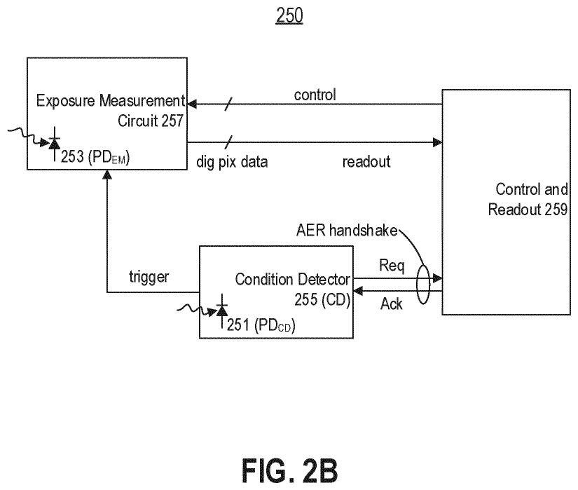

FIG. 2A is a schematic representation of an image sensor pixel 200 for use in a three-dimensional imaging system, consistent with embodiments of the present disclosure. Pixel 200 may be one of a plurality of pixels in an array (e.g., a square, a circle, or any other regular or irregular shape formed by the arrayed pixels).

As used herein, a “pixel” refers to a smallest element of an image sensor that outputs data based on light impinging on the pixel. In some embodiments, a pixel may be larger or include more components because it may include two or more photosensitive elements, other circuitry, or the like, e.g., as depicted in FIG. 2B, described below.

Although the present disclosure refers to a reflection caused by a projected pattern as being received at a single pixel, the projected pattern may include a sufficient number of photons in order to cover and be received by a plurality of pixels. Accordingly, the triangulation described herein may be based on an average location of the plurality of pixels and/or comprise a plurality of triangulations, including the locations of each pixel in the plurality.

As depicted in FIG. 2A, a photosensitive element 201 may generate an electrical signal (e.g., a voltage, a current, or the like) based on brightness of light impinging on element 201. As used herein, a photosensitive element may comprise a photodiode (e.g., a p-n junction or PIN structure) or any other element configured to convert light into an electrical signal. A photodiode may generate a current (e.g., Iₚₕ) proportional to or as a function of the intensity of light impinging on the photodiode.

As further depicted in FIG. 2A, a measurement circuit 205 may convert the current from element 201 to an analog signal for readout. Measurement circuit 205 may activate in response to an external control signal (e.g., an external clock cycle). Additionally, or alternatively, measurement circuit 205 may convert the signal from element 201 to an analog signal that is stored (e.g., in an on-chip and/or off-chip memory (not shown) accessed by pixel 200) until an external control signal is received. In response to the external control signal, measurement circuit 205 may transmit the stored analog signal (the “dig pix data” in FIG. 2A) to a readout system.

Although not depicted in FIG. 2A, an image sensor using pixel 200 may include row and column arbiters or other timing circuitry such that the array of pixels is triggered according to clock cycles, as explained above. Moreover, the timing circuitry may manage the transfer of analog signals to the readout system, as described above, such that collisions are avoided. The readout system may convert the analog signals from the pixel array to digital signals for use in three-dimensional imaging.

FIG. 2B is a schematic representation of an image sensor pixel 250 for use in a three-dimensional imaging system. Pixel 250 may be one of a plurality of pixels in an array (e.g., a square, a circle, or any other regular or irregular shape formed by the arrayed pixels).

As depicted in FIG. 2B, a photosensitive element 251 may generate an electrical signal based on brightness of light impinging on element 251. Pixel 250 may further include a condition detector 255 (CD). In the example of FIG. 2B, detector 255 is electrically connected to the photosensitive element 251 (PDcD) and is configured to generate a trigger signal (labeled “trigger” in the example of FIG. 2B) when an analog signal that is a function of brightness of light impinging on the photosensitive element 251 matches a condition. For example, the condition may comprise whether the analog signal exceeds a threshold (e.g., a voltage or current level). The analog signal may comprise a voltage signal or a current signal.

In the example of FIG. 2B, a photosensitive element 253 may generate an electrical signal based on brightness of light impinging on element 253. Pixel 250 may further include an exposure measurement circuit 257. In the example of FIG. 2B, exposure measurement circuit 257 may be configured to generate a measurement that is a function of brightness of light impinging on the photosensitive element 253 (PD_{EM}). Exposure measurement circuit 257 may generate the measurement in response to the trigger signal, as shown in FIG. 2B. Although depicted as using exposure measurement circuit 257 in FIG. 2B, some embodiments may read the measurement from the photosensitive element 253 directly (e.g., using control and readout system 259) and omit exposure measurement circuit 257.

In some embodiments, exposure measurement circuit 257 may include an analog-to-digital converter. Examples of such embodiments are disclosed in U.S. Provisional Patent Application No. 62/690,948, filed on Jun. 27, 2018, and titled “Image Sensor with a Plurality of Super-Pixels”; and U.S. Provisional Patent Application No. 62/780,913, filed on Dec. 17, 2018, and titled “Image Sensor with a Plurality of Super-Pixels.” The disclosures of these applications are fully incorporated herein by reference. In such embodiments, exposure measurement circuit 257 may reset condition detector 255 (e.g., using a “clear” signal not shown in FIG. 2B) when the measurement is completed and/or transmitted to an external readout system.

In some embodiments, exposure measurement circuit 257 may output the measurement asynchronously to a readout and control system 259. This may be performed using, e.g., an asynchronous event readout (AER) communications protocol or other suitable protocol. In other embodiments, readout from exposure measurement circuit 257 may be clocked using external control signals (e.g., labeled “control” in FIG. 2B). Moreover, as depicted in FIG. 2B, in some embodiments, triggers from detector 259 may also be output to readout and control system 259 using, e.g., an asynchronous event readout (AER) communications protocol or other suitable protocol.

Examples of pixel 250 depicted in FIG. 2B are disclosed in U.S. Pat. No. 8,780,240 and in U.S. Pat. No. 9,967,479. These patents are incorporated herein by reference.

Although depicted as different photosensitive elements, in some embodiments, photosensitive elements 251 and 253 may comprise a single element shared between condition detector 255 and exposure measurement circuit 257. Examples of such embodiments are disclosed in European Patent Application No. 18170201.0, filed on Apr. 30, 2018, and titled “Systems and Methods for Asynchronous, Time-Based Image Sensing.” The disclosure of this application is incorporated herein by reference.

Moreover, although depicted with one condition detector and one exposure measurement circuit, some embodiments may include a plurality of exposure measurement circuits sharing a condition detector, such that a trigger signal causes a plurality of measurements to be captured. Examples of such embodiments are disclosed in U.S. Provisional Patent Application No. 62/690,948, filed on Jun. 27, 2018, and titled “Image Sensor with a Plurality of Super-Pixels”; and U.S. Provisional Patent Application No. 62/780,913, filed on Dec. 17, 2018, and titled “Image Sensor with a Plurality of Super-Pixels. The disclosures of these applications are incorporated herein by reference.

In other embodiments, the exposure measurement circuit may be removed such that only events from the condition detector are output by the image sensor. Accordingly, photosensitive elements 251 and 253 may comprise a single element used only by condition detector 255.

Although not depicted in FIG. 2B, an image sensor using pixel 250 may include row and column lines or other readout circuitry such that events generated by pixel 250 may be read off the image sensor. Moreover, timing circuitry may manage the transfer of analog signals to the readout system, such that collisions are avoided. In any of these embodiments, the readout system may convert the analog signals from the pixel array to digital signals for use in three-dimensional imaging.

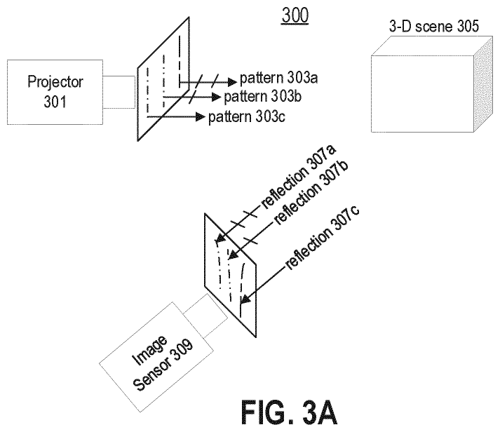

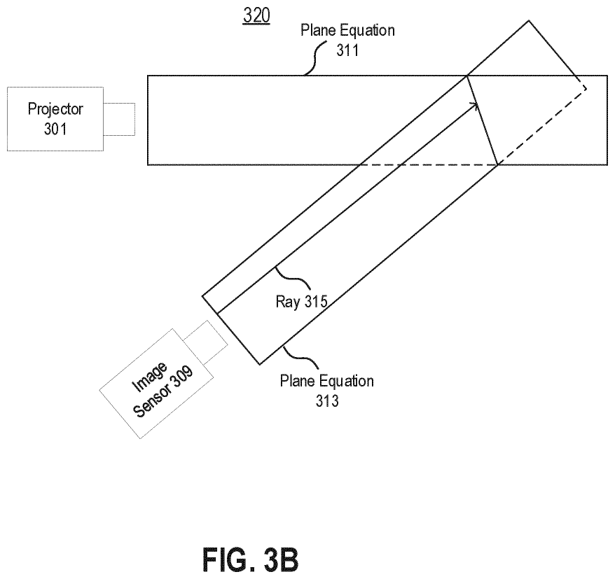

FIG. 3A is a schematic representation of a system 300 for three-dimensional imaging. As shown in FIG. 3A, a projector 301 may transmit lines of electromagnetic pulses according to one or more patterns (e.g., patterns 303a, 303b, and 303c in FIG. 3A). Although depicted as using three patterns, any number of patterns may be used. Because each pattern may correspond to a small portion of a three-dimensional scene 305, a high number (e.g., thousands or even hundreds of thousands) of patterns may be used.

Projector 301 may comprise one or more laser generators or any other device configured to project lines of electromagnetic pulses according to one or more patterns. In some embodiments, projector 301 may be a dot projector. Accordingly, projector 301 may be configured to sweep along the lines while projecting dots in order to project the lines into 3-D scene 305. Alternatively, projector 301 may comprise a laser projector configured to project light forming the lines simultaneous along some or all portions of the lines.

Additionally, or alternatively, projector 301 may include a screen or other filter configured to filter light from projector 301 into the lines. Although not depicted in FIG. 3A, projector 301 may comprise a controller configured to receive commands or to retrieve stored patterns governing generation and projection of lines into scene 305.

In some embodiments, projector 301 may be configured to project the plurality of lines to a plurality of spatial locations in scene 305. The spatial locations may correspond to different pixels (or groups of pixels) of an image sensor 309, further described below. Additionally, or alternatively, projector 301 may be configured to project the plurality of lines at a plurality of different projection times.

In some embodiments, projector 301 may be configured to project a plurality of frequencies, e.g., in order to increase variety within patterns. In other embodiments, projector 301 may be configured to use a single frequency (or range of frequencies), e.g., in order to distinguish reflections caused by the patterns from noise in scene 305. By way of example, the frequencies may be between 50 Hz and a few kHz (e.g., 1 kHz, 2 kHz, 3 kHz, or the like).

The projected lines or other patterns may cause reflections from scene 305. In the example of FIG. 3A, patterns 303a, 303b, and 303c caused reflections 307a, 307b, and 307c, respectively. Although shown as constant in time, the reflections may change angle over time due to dynamics in scene 305. These dynamics may be reconstructed using state machine searches, as explained further below.

The reflections may be captured by an image sensor 309. In some embodiments, image sensor 309 may be an event-based sensor. As explained above, image sensor 309 may comprise an array of pixels 200 of FIG. 2A, an array of pixels 250 of FIG. 2B, or an array of any other pixels, coupled with a readout system. The signals generated by image sensor 309 may be processed by a system including at least one processor (not shown in the figures). As explained below, the system may recreate any dynamics in scene 305 and/or calculate three-dimensional image points for scene 305.

Reflections 307a, 307b, and 307c may form curves on pixels of image sensor 309 even if patterns 303a, 303b, and 303c are arranged along straight lines (as shown in FIG. 3A). For example, varying depths, as well as dynamics within scene 305, may warp patterns 303a, 303b, and 303c to form the curves. Moreover, varying depths, as well as dynamics within scene 305, may further warp the curves to include discontinuities and/or inflection points on the pixels of image sensor 309. System 300 may identify curves captured on image sensor 309 (e.g., formed by reflections 307a, 307b, and 307c) corresponding to projected lines (e.g., encoding patterns 303a, 303b, and 303c) using state machine searches, as explained further below.

FIG. 3B is a graphical representation of three-dimensional imaging 300 using a three-dimensional ray from a received event and a plane equation of an associated line. As shown in FIG. 3B, each line from projector 301 may be associated with a corresponding plane equation 311. For example, plane equation 311 may comprise a′X+b′Y+c′Z+d′=0, where a′, b′, c′, and d′ are constants that define the plane, and where X, Y, and Z are coordinates in a three-dimensional space including scene 305 (not shown in FIG. 3B). Although depicted as finite, plane equation 311 may define an infinite plane. As described above, in some embodiments, projector 301 (e.g., a laser projector) may deform the projected line into a curve. Accordingly, the “line” may refer to a geometric line or to a curved line. In embodiments where the line is curved, plane equation 311 may describe a three-dimensional surface that is warped corresponding to the curvature of the line rather than a straight plane. Accordingly, as used herein, a “plane equation” may refer to an equation for a geometric plane or a warped three-dimensional surface.

As explained above with respect to FIG. 3A, corresponding events received by image sensor 309 may map to a curve of reflections caused by a corresponding line from projector 301. For example, a processor (not shown) in communication with image sensor 309 may use state machines to connect events across time to determine the curve. Moreover, in some embodiments, the connected events may spread across pixels of image sensor 309. The curve may also have a corresponding plane equation 313 as described above, with reference to FIG. 3B, although the processor need not calculate plane equation 313 to calculate three-dimensional points for scene 305 (not shown in FIG. 3B). Further, by way of example, the processor may, for each point along the identified curve, calculate a plurality of rays originating from image sensor 309.

For example, the projection of a straight line into three-dimensional (3D) space corresponds to a 3D plane, whose corresponding plane equation may comprise a′X+b′Y+c′Z+d′=0 (equation 1), where X, Y, and Z are coordinates of points lying on the plane in 3D space, and a′, b′, c′, and d′ are constants defining the plane. The origin is the camera optical center, at position (0, 0, 0). For a pixel (i, j) on the sensor, located in the i'th pixel row and j'th pixel column, the pixel position in 3D space can be identified using sensor calibration parameters, a (x, y, f), where f is the focal length according to a pin-hole camera model. All 3D points projecting to (i, j) on the sensor are on the 3D ray that passes through (x, y, f) and the optical center (0, 0, 0). For all 3D points on the ray, there exists a scalar constant A as defined by the following (equation 2):

$$( \begin{matrix}X \\ Y \\ Z\end{matrix} ) = λ ( \begin{matrix}x \\ y \\ f\end{matrix} )$$

To triangulate the 3D point at the intersection of the 3D plane from the projector and the 3D ray from the camera, equation 2 can be injected into equation 1 as:

a′λx+b′λy+c′λf+d′=0

which yields

$$λ = \frac{- {d}^{′}}{{a}^{′} x + {b}^{′} y + {c}^{′} f}$$

$$and \\ ( \begin{matrix}X \\ Y \\ Z\end{matrix} ) = \frac{- {d}^{′}}{{a}^{′} x + {b}^{′} y + {c}^{′} f} ( \begin{matrix}x \\ y \\ f\end{matrix} )$$

In some embodiments, the projection is a curved line into 3D space. In such a case, this is no longer a plane, but a curved surface. Therefore, another triangulation operation may be used as opposed to one based on the above-referenced plane equation. For example, a quadratic surface model may be used, of the general equation:

$$( X Y Z ) Q ( \begin{matrix}X \\ Y \\ Z\end{matrix} ) + P ( \begin{matrix}X \\ Y \\ Z\end{matrix} ) + R = 0$$

where Q is a 3×3 matrix, P is a three-dimensional row vector, and R is a scalar constant. Triangulating a 3D point at the intersection of a 3D ray from the camera and the 3D surface is possible by injecting equation 2 into the quadratic surface equation and solving for A.

Consistent with some embodiments, the processor may further select the ray intersecting with plane equation 311 (ray 315 in the example of FIG. 3B). For example, the processor may select the ray intersecting with plane equation 311 by mapping a pattern (or encoded symbol) in the reflections received by image sensor 309 to a pattern associated with the line corresponding to plane equation 311, as explained further below.

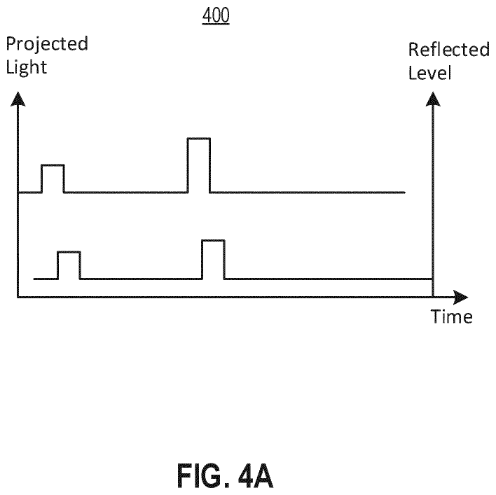

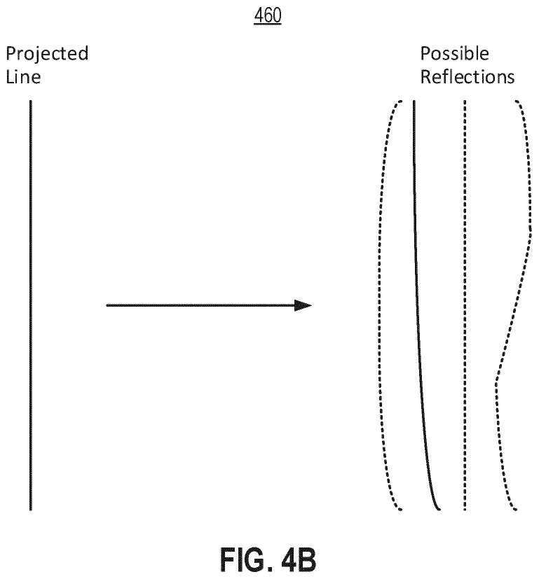

FIG. 4A is a schematic representation of electromagnetic patterns transformed by geometry within a scene, consistent with the present disclosure. As explained above, with reference to the examples of FIGS. 1A and 1B, state machines may describe any temporal distortions of an electromagnetic pattern or any spatial distortions of the same. The temporal distortions may, for example, inhibit decoding of a symbol encoded in characteristics of the pattern. The spatial distortions may, for example, spread the symbol across a plurality of pixels of an image sensor receiving the patterns.

FIG. 4A depicts an example pattern transformed to a different temporal pattern by geometry within a scene. For example, geometry 400 transforms the depicted pattern by delaying it. In another example (not shown), geometry may transform the depicted pattern by moving the pulses closer in time. By using state machines to connect events despite such distortions between projection and reflection, embodiments of the present disclosure may map a received curve to a projected line despite transformations that may otherwise inhibit proper decoding of the pattern.

Although not shown in FIG. 4A, geometry of a scene may additionally or alternatively transform patterns across space such that different portions of the pattern are received at different pixels of an image sensor (e.g., image sensor 309). Accordingly, any detected patterns may be mapped back to projected patterns using one or more state machines, whether calculated using at least one processor, searching a database of known state machines, or the like.

In another example, FIG. 4B depicts a graphical representation of mapping a reflected curve to a projected line using state machines. For example, as shown in FIG. 4B, a projected line may map to a plurality of curves (in some embodiments, even infinite possible curves). Accordingly, if a processor associated with an image sensor (e.g., image sensor 309) receives events corresponding to signals generated by reflections (e.g., caused by the projected line) received at the image sensor, the processor may determine state machine candidates for connecting the events across pixels to decode a pattern associated with the projected line. In some embodiments, the processor may also connect the events across pixels into a curve. Accordingly, the processor may use the determined candidates to identify which curve of the plurality of curves corresponds to the projected line.

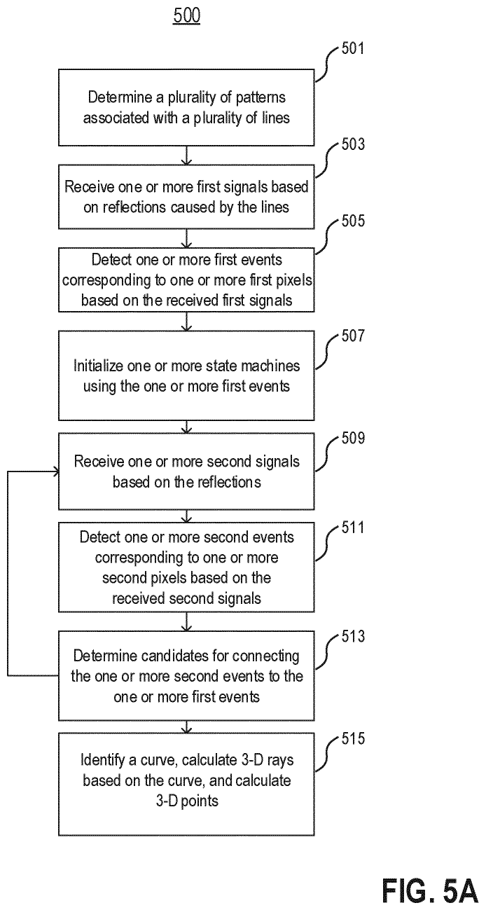

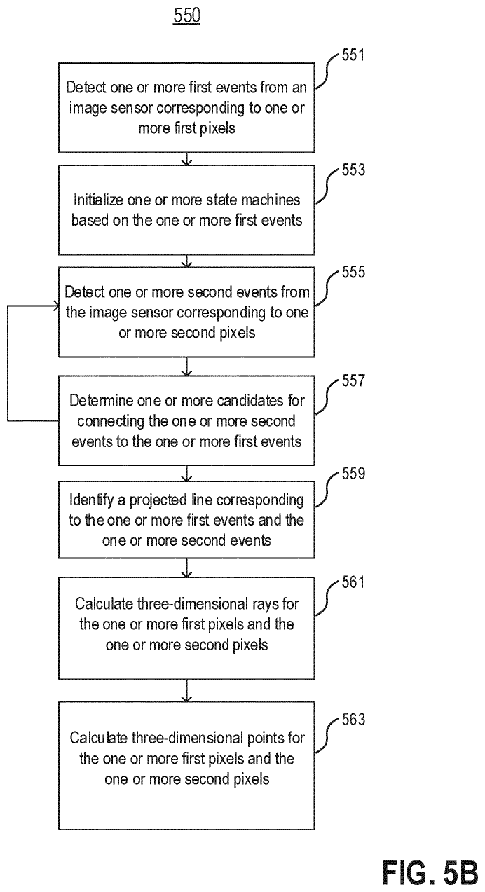

FIG. 5A is a flowchart of an exemplary method 500 for detecting three-dimensional images, consistent with embodiments of the present disclosure. Method 500 of FIG. 5A may be performed using at least one processor. The at least one processor may be integrated as a microprocessor on the same chip as an image sensor (e.g., image sensor 200 of FIG. 2A, image sensor 250 of FIG. 2B, or the like) or provided separately as part of a processing system. The at least one processor may be in electrical communication with the projector and image sensor of the system for purposes of sending and receiving signals, as further disclosed herein.

At step 501, the at least one processor may determine a plurality of patterns associated with a plurality of lines comprising electromagnetic pulses emitted by a projector (e.g., projector 301 of FIG. 3) onto a scene (e.g., scene 305 of FIG. 3). For example, as explained above, determining the plurality of patterns may comprise receiving digital signals (e.g., using an on-chip bus connected to at least one transmitter configured to communicate over at least one network, to at least one memory, or the like) defining amplitudes separated by time intervals. In such embodiments, the digital signals defining amplitudes separated by time intervals may be received from a controller associated with a projector configured to project a plurality of electromagnetic pulses according to the plurality of patterns. Additionally, or alternatively, the digital signals defining amplitudes separated by time intervals may be retrieved from at least one non-transitory memory storing patterns.

In some embodiments, the at least one processor may also send commands to the projector configured to project a plurality of electromagnetic pulses onto a scene such that the projector transmits the plurality of electromagnetic pulses according to the patterns. For example, the at least one processor may use an on-chip bus, a wire or other off-chip bus, at least one transmitter configured to communicate over at least one bus, wire, or network, or any combination thereof to send commands to the projector.

As further explained above, the patterns may comprise any series of pulses of electromagnetic radiation over a period of time. For example, a pattern may define one or more pulses by amplitude and/or length of time along the period of time of the pattern. Accordingly, the plurality of patterns may comprise at least two different amplitudes separated by a length of time, at least two different wavelengths separated by a length of time, at least two different pulse lengths separated by a length of time, a plurality of pulses separated by different lengths of time, or the like. Moreover, as described above, the pattern may have at least one of selected frequencies, phase shifts, or duty cycles used to encode symbols (see, e.g., the explanation below with respect to FIG. 7).

In some embodiments, the at least one processor may encode a plurality of symbols into the plurality of patterns. As explained above, the plurality of patterns may be associated with the plurality of lines. The symbols may comprise letters, numbers, or any other communicative content encoded into electromagnetic patterns. In some embodiments, the plurality of symbols relating to at least one spatial property of the plurality of lines. For example, the plurality of symbols may encode an expected frequency or brightness of the electromagnetic pulses, a spatial location associated with the electromagnetic pulses (such as a spatial coordinate of the projector projecting the pulses), or the like.

Referring again to FIG. 5A, at step 503, the at least one processor may receive, from an image sensor, one or more first signals based on reflections caused by the plurality of electromagnetic pulses. For example, as explained above, measurement circuit 205 may convert a signal from photosensitive element 201 into an analog signal that is a function of brightness of light impinging on photosensitive element 201. The at least one processor may receive analog signals from measurement circuit 205 as the one or more first signals or may receive digital signals based on the analog signals from an analog-to-digital converter in communication with measurement circuit 205. Additionally, or alternatively, as explained above, condition detector 255 (CD) may generate a trigger signal (e.g., a “set” signal in the example of FIG. 2B) when a first analog signal based on light impinging on photosensitive element 251 exceeds a predetermined threshold, and exposure measurement circuit 257 may convert a signal from photosensitive element 253 into a second analog signal that is a function of brightness of light impinging on photosensitive element 253 in response to the trigger signal. The at least one processor may receive second analog signals from exposure measurement circuit 257 as the one or more first signals or may receive digital signals based on the second analog signals from an analog-to-digital converter in communication with (or forming a portion of) exposure measurement circuit 257.

At step 505, the at least one processor may detect one or more first events corresponding to one or more first pixels of the image sensor based on the received first signals. For example, an event may be detected based on a polarity change between two signals of the one or more first signals, changes in amplitude between two signals of the one or more first signals having magnitudes greater than one or more thresholds, or the like. As used herein, a “polarity change” may refer to a change in amplitude, either increasing or decreasing, detected in the one or more first signals. In embodiments using an event-based image sensor such as image sensor 250 of FIG. 2B, the one or more first signals may themselves encode the one or more first events. Accordingly, the at least one processor may detect the one or more first events by distinguishing the one or more first signals.

In some embodiments, the at least one processor may associate the one or more first events with the one or more first pixels based on addresses encoded with the one or more first signals by the image sensor. For example, the image sensor (or a readout system in communication with the image sensor) may encode an address of the pixel(s) from which the one or more first signals originated. Accordingly, the at least one processor may associate the one or more first events with the one or more first pixels based on addresses encoded with the one or more first signals. In such embodiments, the at least one processor is adapted to decode and obtain the address from the one or more first signals.

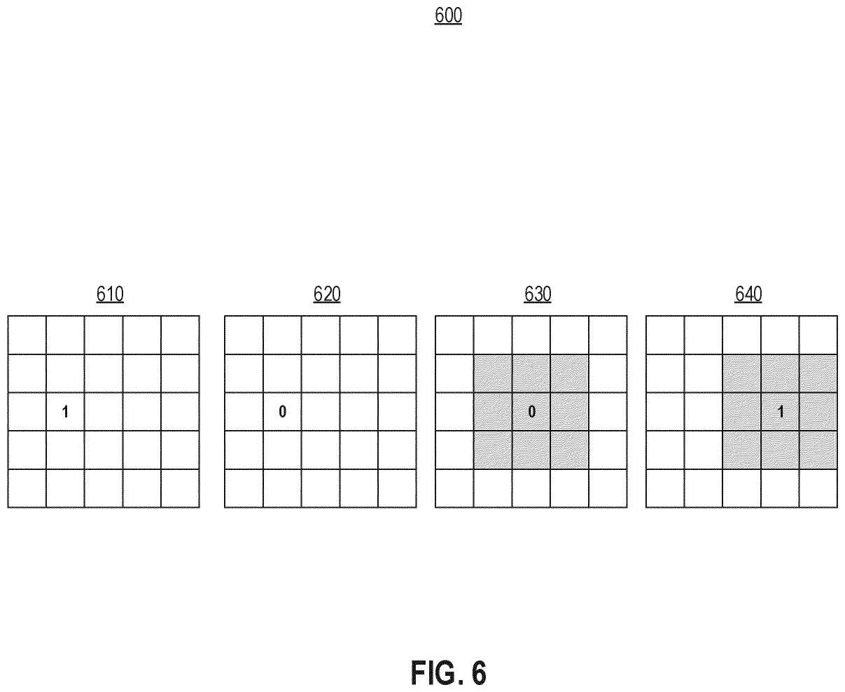

At step 507, the at least one processor may initialize one or more state machines based on the one or more first events. For example, the at least one processor may initialize a state machine for the one or more first pixels. Additionally, in some embodiments, the at least one processor may initialize a state machine for neighboring pixels. As explained below, with respect to FIG. 6, the initialization may include identifying portions of the plurality of patterns corresponding to expected reflections that caused portions of the one or more first events.

At step 509, the at least one processor may receive, using the image sensor, one or more second signals based on the reflections. For example, the at least one processor may receive the one or more second signals from image sensor 200 of FIG. 2A, image sensor 250 of FIG. 2B, or the like. In embodiments using a synchronous image sensor, the one or more second signals may have been captured in a different clock cycle. In embodiments using an asynchronous image sensor, the one or more second signals may have been captured at any time after the one or more first signals. In embodiments using an asynchronous image sensor, the readout may be clocked such that the at least one processor receives the one or more second signals in a different clock cycle than it received the one or more first signals.

At step 511, the at least one processor may detect one or more second events corresponding to one or more second pixels of the image sensor based on the received second signals. For example, the at least one processor may detect the one or more second events based on a polarity change between two signals of the one or more second signals, changes in amplitude between two signals of the one or more second signals having magnitudes greater than one or more thresholds, or the like. In embodiments using an event-based image sensor such as image sensor 250 of FIG. 2B, the one or more first signals may themselves encode the one or more second events.

At step 513, the at least one processor may determine candidates for connecting the one or more second events to the one or more first events. For example, as explained below with respect to FIG. 6, the candidates may be based on locations of the one or more second pixels with respect to the one or more first pixels. Additionally, or alternatively, any changes in amplitude, polarity, or the like different from those expected based on the plurality of patterns should be encapsulated in the candidates. In some embodiments, the at least one processor may use the plurality of patterns and the one or more state machines to determine the candidates.

As depicted in FIG. 4B, the candidates may connect the one or more second events and the one or more first events to identify a curve on the image sensor. Additionally, or alternatively, the candidates may connect the one or more second events and the one or more first events to correct for a drift of the reflections from the one or more first pixels to the one or more second pixels. For example, the one or more second events may be timestamped after the one or more first events such that the candidates connect the one or more first events to the one or more second events temporally. One example of such temporal mapping is depicted in FIG. 4A explained above.

Referring again to the example of FIG. 5A, method 500 may be recursive. For example, the at least one processor may repeat steps 509, 511, and 513 with each new set of signals from the image sensor (e.g., generated and/or received in the next clock cycle). Any change in the signals across pixels may then trigger a state machine search in step 513. This may repeat for a predetermined period of time or until one or more final events corresponding to ends of the plurality of patterns are detected.

At step 515, the at least one processor may use the candidates to identify a curved formed by the one or more second events and the one or more first events. For example, as explained above with respect to FIG. 4B, the at least one processor may connect the one or more first events and the one or more second events to form a curve on the pixels of the image sensor to eliminate other (possibly infinite) possible curves mapping to a projected line.

Step 515 may further include calculating three-dimensional rays for the one or more first pixels and the one or more second pixels based on the identified curve. For example, as depicted in FIG. 3B, the at least one processor may calculate rays originating from the image sensor for points within the identified curve.

As part of step 515, the at least one processor may also calculate three-dimensional image points for the one or more first pixels and the one or more second pixels based on the three-dimensional rays and a plane equation associated with one of the lines corresponding to the identified curve. For example, as depicted in FIG. 3B, the three-dimensional points may comprise the intersection between the rays originating from the image sensor and the associated plane equation. As explained above, the pattern (or encoded symbol) within the received reflections causing the one or more first events and the one or more second events connected into the identified curve may map to the associated plane equation. For example, the at least one processor may access a controller for the projector, a non-transitory memory storing one or more plane equations, or the like in order to map the pattern to the associated plane equation.

For example, if a pixel generated a series of signals whose events map to a pattern of the plurality of patterns (e.g., through a fully-known state machine), then the three-dimensional ray from that pixel may be projected to a plane equation determined using the pattern. In some embodiments, the pattern may encode one or more symbols indexed or otherwise indicate the plane equation associated with the pattern. The at least one processor may thus obtain the plane equation and extract the location of the pixel (e.g., for originating the three-dimensional ray) that received the reflection therefrom based on the address encoded in the signals from the image sensor.

In some embodiments, the pattern may be identified or predicted at every event reception and thereby increase temporal density while keeping the latency associated with the code. This identification could be carried from one transmission of the code to the next if the codes are looped or associated, which could enable the prediction the code being decoded while it is received (i.e., the code may be predicted to be the same as previously obtained as long as the received bits are coherent with it).

If a pattern of the plurality of patterns caused reflections that spread across a plurality of pixels (e.g., due to dynamic motion in the scene), then the three-dimensional point at the final pixel (e.g., the pixel generating a final signal corresponding to an end of a pattern of the plurality of patterns) may be determined using a three-dimensional ray originating from the final pixel and based on the plane equation associated with the pattern. The at least one processor may then proceed backward (in time) from the final signal to finalize state machines for other pixels in the plurality of pixels receiving the reflections. For example, the image sensor may encode a timestamp on each measurement from pixels such that the at least one processor has past timestamps for previous pixels as well as timestamps for recent pixels. Thus, the three-dimensional points at these other pixels may be determined using three-dimensional rays originating from the other pixels and based on the plane equation associated with the pattern, and these points may be associated with the past timestamps.

In addition to or in lieu of step 515, method 500 may include using the candidates and the one or more state machines to decode the one or more first events and the one or more second events to obtain at least one spatial property. For example, the at least one spatial property may comprise a plane equation associated with the pattern such that the at least one processor may use the decoded plane equation to determine three-dimensional points. Additionally, or alternatively, the at least one spatial property may comprise a frequency, a brightness, or the like such that the at least one processor may use the decoded at least one spatial property in mapping the one or more first events and the one or more second events to a corresponding pattern.

FIG. 5B is a flowchart of another exemplary method 550 for detecting three-dimensional images, consistent with embodiments of the present disclosure. Method 550 of FIG. 5B may be performed using at least one processor. The at least one processor may be integrated as a microprocessor on the same chip as an image sensor (e.g., image sensor 200 of FIG. 2A, image sensor 250 of FIG. 2B, or the like) or provided separately as part of a processing system. The at least one processor may be in electrical communication with the projector and image sensor of the system for purposes of sending and receiving signals, as further disclosed herein. Further, as disclosed herein, the image sensor may include a plurality of pixels and be configured to detect reflections in a scene caused by projected patterns.

At step 551, the at least one processor may detect one or more first events corresponding to one or more first pixels of the image sensor based on reflections. As disclosed herein, the reflections may be caused by a plurality of electromagnetic pulses emitted by a projector (e.g., projector 301 of FIG. 3) onto a scene (e.g., scene 305 of FIG. 3). By way of example, an event may be detected based on a polarity change between two signals of one or more first signals, changes in amplitude between two signals of one or more first signals having magnitudes greater than one or more thresholds, or the like. As used herein, a “polarity change” may refer to a change in amplitude, either increasing or decreasing, detected in one or more first signals. In embodiments using an event-based image sensor such as image sensor 250 of FIG. 2B, one or more first signals generated based on the reflections may themselves encode the one or more first events. Accordingly, the at least one processor may detect the one or more first events by distinguishing the one or more first signals.

In some embodiments, the at least one processor may associate the one or more first events with the one or more first pixels based on addresses encoded with one or more first signals by the image sensor. For example, the image sensor (or a readout system in communication with the image sensor) may encode an address of the pixel(s) from which one or more first signals originated. Accordingly, the at least one processor may associate the one or more first events with the one or more first pixels based on addresses encoded with the one or more first signals. In such embodiments, the at least one processor is adapted to decode and obtain the address from the one or more first signals.

The reflections may be caused by a plurality of electromagnetic pulses emitted by a projector (e.g., projector 301 of FIG. 3) onto a scene (e.g., scene 305 of FIG. 3). As explained above, the projected pulses may comprise a plurality of patterns projected across a plurality of lines.

At step 553, the at least one processor may initialize one or more state machines based on the one or more first events. For example, the at least one processor may initialize a state machine for the one or more first pixels. Additionally, in some embodiments, the at least one processor may initialize a state machine for neighboring pixels. As explained below, with respect to FIG. 6, the initialization may include identifying portions of the plurality of patterns corresponding to expected reflections that caused portions of the one or more first events.

At step 555, the at least one processor may detect one or more second events corresponding to one or more second pixels of the image sensor based on reflections. For example, the at least one processor may detect the one or more second events based on a polarity change between two signals of one or more second signals, changes in amplitude between two signals of one or more second signals having magnitudes greater than one or more thresholds, or the like. In embodiments using an event-based image sensor such as image sensor 250 of FIG. 2B, one or more second signals may themselves encode the one or more second events. Moreover, as explained above with respect to step 551, the reflections may be caused by a plurality of electromagnetic pulses emitted by a projector (e.g., projector 301 of FIG. 3) onto a scene (e.g., scene 305 of FIG. 3).

At step 557, the at least one processor may determine one or more candidates for connecting the one or more second events to the one or more first events. For example, as explained below with respect to FIG. 6, the candidates may be based on locations of the one or more second pixels with respect to the one or more first pixels. Additionally, or alternatively, any changes in amplitude, polarity, or the like different from those expected based on the plurality of patterns should be encapsulated in the candidates. In some embodiments, the at least one processor may use the plurality of patterns and the one or more state machines to determine the candidates.

As depicted in FIG. 4B, the candidates may connect the one or more second events and the one or more first events to identify a curve on the image sensor. Additionally, or alternatively, the candidates may connect the one or more second events and the one or more first events to correct for a drift of the reflections from the one or more first pixels to the one or more second pixels. For example, the one or more second events may be timestamped after the one or more first events such that the candidates connect the one or more first events to the one or more second events temporally. One example of such temporal mapping is depicted in FIG. 4A, explained above.

Referring again to the example of FIG. 5B, method 550 may be recursive. For example, the at least one processor may repeat steps 555 and 557 with each new set of signals from the image sensor (e.g., generated and/or received in the next clock cycle). Any change in the signals across pixels may then trigger a state machine search in step 557. This may repeat for a predetermined period of time or until one or more final events corresponding to ends of the plurality of patterns are detected.

At step 559, the at least one processor may use the one or more candidates to identify a projected line corresponding to the one or more second events and the one or more first events. For example, as explained above with respect to FIG. 4B, the at least one processor may connect the one or more first events and the one or more second events to form a curve on the pixels of the image sensor and map the curve to a projected line, e.g., based on signals from the projector with a pattern associated with the projected line, a stored database of projected line patterns, or the like.

At step 561, the at least one processor may calculate three-dimensional rays for the one or more first pixels and the one or more second pixels based on the identified line. For example, as depicted in FIG. 3B, the at least one processor may calculate rays originating from the image sensor for points within the identified curve.

At step 563, the at least one processor may calculate three-dimensional image points for the one or more first pixels and the one or more second pixels based on the three-dimensional rays and a plane equation associated with one of the lines corresponding to the identified line. For example, as depicted in FIG. 3B, the three-dimensional points may comprise the intersection between the rays originating from the image sensor and the associated plane equation. As explained above, the pattern (or encoded symbol) within the received reflections causing the one or more first events and the one or more second events connected into the identified curve may map to the associated plane equation. For example, the at least one processor may access a controller for the projector, a non-transitory memory storing one or more plane equations, or the like in order to map the pattern to the associated plane equation.

For example, if a pixel generated a series of signals whose events map to a pattern of the plurality of patterns (e.g., through a fully-known state machine), then the three-dimensional ray from that pixel may be projected to a plane equation determined using the pattern. In some embodiments, the pattern may encode one or more symbols indexed or otherwise indicate the plane equation associated with the pattern. The at least one processor may thus obtain the plane equation and extract the location of the pixel (e.g., for originating the three-dimensional ray) that received the reflection therefrom based on the address encoded in the signals from the image sensor.

If a pattern of the plurality of patterns caused reflections that spread across a plurality of pixels (e.g., due to dynamic motion in the scene), then the three-dimensional point at the final pixel (e.g., the pixel generating a final signal corresponding to an end of a pattern of the plurality of patterns) may be determined using a three-dimensional ray originating from the final pixel and based on the plane equation associated with the pattern. The at least one processor may then proceed backward (in time) from the final signal to finalize state machines for other pixels in the plurality of pixels receiving the reflections. For example, the image sensor may encode a timestamp on each measurement from pixels such that the at least one processor has past timestamps for previous pixels as well as timestamps for recent pixels. Thus, the three-dimensional points at these other pixels may be determined using three-dimensional rays originating from the other pixels and based on the plane equation associated with the pattern, and these points may be associated with the past timestamps.

In addition to or in lieu of step 559, method 500 may include using the candidates and the one or more state machines to decode the one or more first events and the one or more second events to obtain at least one spatial property. For example, the at least one spatial property may comprise a plane equation associated with the pattern such that the at least one processor may use the decoded plane equation to determine three-dimensional points. Additionally, or alternatively, the at least one spatial property may comprise a frequency, a brightness, or the like such that the at least one processor may use the decoded at least one spatial property in mapping the one or more first events and the one or more second events to a corresponding pattern.

Consistent with the present disclosure, the projected patterns (e.g., from projector 301 of FIG. 3) may encode one or more symbols that are indexed to locations from which the patterns were projected. FIG. 6 is a diagram that illustrates an example of a state machine search (e.g., based on step 507 and recursive execution of step 513 of FIG. 5A) or based on step 553 and recursive execution of step 557 of FIG. 5B) to allow for decoding of such symbols across a plurality of pixels. As depicted in FIG. 6, step 610 (which may, for example, correspond to step 507 of FIG. 5A or step 553 of FIG. 5B) may include initializing a state machine based on one or more initial events (e.g., depicted as encoding a “1” symbol in step 610) detected at a first pixel. The initial event(s) may be based on one or more signals received from the first pixel. One or more subsequent events (e.g., depicted as encoding a “0” symbol in step 620) may also be detected at the first pixel. These subsequent events link to the initial event(s) through a fully-known state machine. Thus, the “1” symbol and “0” symbol are connected to form the beginning of a set of symbols indexed to a location from which the corresponding pattern was projected.

In cases of a dynamic scene, one or more subsequent events, e.g., depicted as encoding a “0” symbol in step 630, may be received at a different pixel than the first pixel, as would be expected from the state machine. Accordingly, as shown in FIG. 6, the at least one processor may search neighboring pixels (represented by the shaded area) to connect these subsequent events to previous event(s) (the events encoding the symbols depicted in steps 610 and 620 in the example of FIG. 6). Accordingly, the state machines of the previous event(s) may remain unfinished (e.g., the state machine remains at “1” followed by “0”) and a new candidate state machine (describing “1” followed by “0” and then “0” again) added to the different pixel.

At step 640, one or more subsequent events, e.g., depicted as encoding a “1” symbol, may be received at a different pixel than in step 630, as would be expected from the state machine. Accordingly, as shown in FIG. 6, the at least one processor may again search neighboring pixels (represented by the shaded area) to connect these subsequent events to previous event(s) (the events encoding the symbol depicted in step 630 in the example of FIG. 6). Accordingly, the state machines of the previous event(s) may remain unfinished (e.g., the state machine remains at “1” followed by two “0”s) and a new candidate state machine (describing “1” followed by two “0”s followed by a “1”) added to the different pixel.

Consistent with the present disclosure, when one or more events are detected corresponding to an end of one or more of the plurality of patterns (e.g., encoding a symbol that ends the sequence of symbols indexed to the location from which the corresponding pattern was projected), the at least one processor may complete the state machine for the current pixel and then proceed backward in time to complete the state machines of pixels for the previous event(s). Additionally, or alternatively, the at least one processor may complete the state machine when a sufficient number of events (e.g., first events, second events, and the like) have been received such that the at least one processor may distinguish between the plurality of projected patterns.

Additionally, or alternatively, to the decoding process of FIG. 6, embodiments of the present disclosure may use the incomplete state machines for triangulation as well as the finalized state machine. For example, each decoded symbol may be mapped, using a current state machine associated with that pixel, to the most likely pattern, and use the location of the projector indexed to the most likely pattern for triangulation with the location of that pixel. Thus, even if the state machine is incomplete because the end of a pattern is not yet detected, triangulation may occur with varying degrees of accuracy depending on how many symbols have already been decoded (either at the current pixel or at one or more previous pixels). Additionally, or alternatively, the at least one processor may assume that the pattern currently being decoded is the same pattern as that previously received at the same or a nearby pixel. For example, the at least one processor may perform this assumption when the projector transmits the same pattern repeatedly in succession towards the same location in the scene.

In some embodiments, one or more error corrections may be encoded in the symbols. For example, one or more additional symbols at the end of the pattern may comprise error correction symbols, such as a checksum (like a check bit, parity bit, or the like) or other block correction code. Additionally, or alternatively, one or more additional symbols may be added amongst the pattern to form a convolutional correction code or other continuous correction code. In addition, with or in lieu of such error corrections, the projector may also be configured to project the patterns in a temporal loop such that the system excepts to receive the same patterns over and over. Accordingly, one lost pattern will result in one lost depth calculation but will not impact the overall series of three-dimensional images except for a single frame loss. Moreover, this lost frame may be recovered using extrapolation from neighboring frames.

Although depicted using “0” and “1,” any number of symbols may be used based on a dictionary of symbols corresponding to characteristics of electromagnetic pulses (e.g., storing characteristics of pulses in association with particular symbols). Having a larger dictionary may allow for generating a set of unique patterns that are shorter in length.

Moreover, although described using a simple neighbor search, the state machine search may be conducted along an epipolar line or any other appropriate area of pixels for searching. For example, as explained with respect to FIG. 4B, the state machine search may be conducted along one or more expected curves in order to identify the curve corresponding to the projected line. Moreover, FIG. 7 depicts an example method 700 for connecting events detected using the image sensor, e.g., image sensor 200 of FIG. 2A, image sensor 250 of FIG. 2B, or the like, into a cluster.

FIG. 7 is a flowchart of an exemplary method 700 for connecting events from an image sensor into clusters, consistent with embodiments of the present disclosure. Method 700 of FIG. 7 may be performed using at least one processor, whether integrated as a microprocessor on the same chip as an image sensor (e.g., image sensor 200 of FIG. 2A, image sensor 250 of FIG. 2B, or the like) or provided separately as part of a processing system. The at least one processor may be in electrical communication with the image sensor for purposes of sending and receiving signals, as further disclosed herein.

At step 701, the at least one processor may receive an event from an image sensor (e.g., image sensor 200 of FIG. 2A, image sensor 250 of FIG. 2B, or the like). As described above with respect to step 505 of method 500, the event may comprise a signal from an event-based image sensor or an event extracted from signals of a continuous image sensor (e.g., using a clock circuit).

At step 703, the at least one processor may connect the received event to a most recent event if at least one connectivity criterion is met. For example, the at least one processor may determine a temporal distance between the received event and the most recent event and connect them if the temporal distance satisfies a threshold. Additionally, or alternatively, the at least one processor may determine a spatial distance between the received event and the most recent event and connect them if the spatial distance satisfies a threshold. Accordingly, the at least one connectivity criterion may comprise a temporal threshold, a spatial threshold, or any combination thereof. In one combinatory example, the spatial threshold may be adjusted based on which of a plurality of temporal thresholds are satisfied. In such an example, events closer in time may be expected to be closer in space. In another combinatory example, the temporal threshold may be adjusted based on which of a plurality of spatial thresholds are satisfied. In such an example, events closer in space may be expected to be closer in time.

At step 705, the at least one processor may determine whether the at least one connectivity criterion is satisfied for other recent events. For example, the at least one processor may use the at least one connectivity criterion to find all other recent events related to the received event

At step 707, the at least one processor may merge cluster identifiers associated with all recent events for which the at least one connectivity criterion is satisfied. Accordingly, all recent events from steps 703 and 705 that satisfy the at least one connectivity criterion will be assigned the same cluster identifier as that of the event received at step 701.

At step 709, the at least one processor may output the cluster as a set of related events. For example, all events having the same cluster identifier may be output.

Exemplary embodiments and features that may be used for method 700 are described in European Patent Application No. 19154401.4, filed on Jan. 30, 2019, and titled “Method of Processing Information from an Event-Based Sensor.” This disclosure of this application is incorporated herein by reference.

The cluster algorithm of method 700 may be used to perform the search of FIG. 6 rather than searching neighboring pixels. For example, the connectivity criteria of steps 703 and 705 may be used to identify which pixels should be searched. Moreover, any pixels already having the same cluster identifier may also be included in the search.

Additionally, or alternatively, method 700 may be used to cluster raw events received from the image sensor such that each cluster is then decoded, and decoded symbols of that cluster are connected via state machines. Accordingly, rather than decoding each symbol and connecting the symbols sequentially, the decoding and connecting may be performed after clustering to reduce noise.

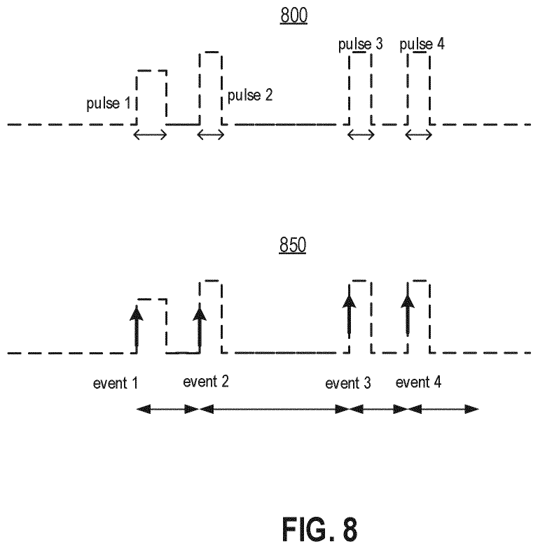

FIG. 8 is a diagram that illustrates two techniques for symbol encoding based on events detected from signals of an image sensor (e.g., image sensor 200 of FIG. 2A, image sensor 250 of FIG. 2B, or the like). As shown in example 800 of FIG. 8, detected events may signal beginnings and endings of projected pulses detected from signals of the image sensor. For example, brightness of light on image sensor 200 of FIG. 2A may be tracked across time and increases or decreases in amplitude detected therefrom, where increases may indicate a start of a projected pulse, and a corresponding decrease may indicate an end of a projected pulse. In another example, image sensor 250 of FIG. 2B is event-based, and thus any signals therefrom may represent increases or decreases in amplitude that caused a trigger signal. Possible patterns may be decoded using the detected changes, allowing for identification of which pattern was received. Although not shown in example 800, different pulses may encode different symbols; e.g., pulses 1, 3, and 4 may encode a “1” symbol while pulse 2 may encode a “0” symbol. Thus, example 800 may be decoded as “1011.”

In example 850 of FIG. 8, determined times between detected pulses are used for decoding. For example, brightness of light on image sensor 200 of FIG. 2A may be tracked across time, and changes in amplitude detected therefrom. In another example, image sensor 250 of FIG. 2B is event-based and thus, any signals therefrom may represent changes in amplitude that caused a trigger signal. Possible patterns may be decoded using temporal spaces between pulses, allowing for identification of which pattern was received. Although not shown in example 850, the different temporal spaces may encode different symbols. For example, in example 850, the spaces between pulses 1 and 2, between pulses 3 and 4, and between pulse 4 and an end of pattern may encode a “1” symbol; on the other hand, the space between pulses 2 and 3 may encode a “0” symbol. Thus, example 850, similar to example 800, may be decoded as “1011.”

Other techniques for matching (not depicted in FIG. 8) may include tracking of detected amplitudes of light at a plurality of times and identifying which pattern was received based thereon. For example, brightness of light on image sensor 200 of FIG. 2A may be tracked across time, and changes in amplitude detected therefrom. In another example, image sensor 250 of FIG. 2B is event-based and thus, any signals therefrom may represent changes in amplitude that caused a trigger signal. Possible patterns may be decoded using symbols corresponding to particular amplitudes and/or symbols corresponding to temporal lengths of particular amplitudes, allowing for identification of which pattern was received.

In another example, frequency of light on image sensor 200 of FIG. 2A may be tracked across time, and changes in frequency detected therefrom. Possible patterns may be decoded using symbols corresponding to particular frequencies and/or symbols corresponding to temporal lengths of particular frequencies, allowing for identification of which pattern was received.

Although not depicted in FIG. 8, some detected events may be discarded. For example, at least one processor performing the three-dimensional imaging may discard any of the digital signals that are separated by an amount of time larger than a threshold and/or by an amount of time smaller than a threshold. By using software or logic-based low bandpass filter and/or high bandpass filter, respectively, the system may further increase the accuracy of pattern detection and decrease noise. The low bandpass filters and/or high bandpass filters may be implemented in software, or they may be implemented in firmware or hardware, e.g., by integration into measurement circuit 205 of FIG. 2A, exposure measurement circuit 257 of FIG. 2B, a readout system connected to the image sensor, or the like. For example, hardware implementation of a bandpass filter may include modifying analog settings of the sensor.

Similarly, the at least one processor performing the three-dimensional imaging may additionally or alternatively discard any of the digital signals associated with a bandwidth not within a predetermined threshold range. For example, a projector emitting the plurality of patterns onto the scene may be configured to project electromagnetic pulses within a particular frequency (and thus bandwidth) range. Accordingly, the system may use a bandwidth filter (in hardware and/or in software) to filter noise and only capture frequencies corresponding to those emitted by the projector. Additionally, or alternatively, the system may use a bandwidth filter (in hardware and/or in software) to filter high-frequency and/or low-frequency light in order to reduce noise.

In addition to or in lieu of the software and/or hardware bandpass and/or frequency filters described above, the system may include one more optical filters used to filter light from the scene impinging on the image sensor. For example, with respect to FIGS. 2A and 2B, the optical filter(s) may be configured to block any reflections associated with a wavelength not within a predetermined range.

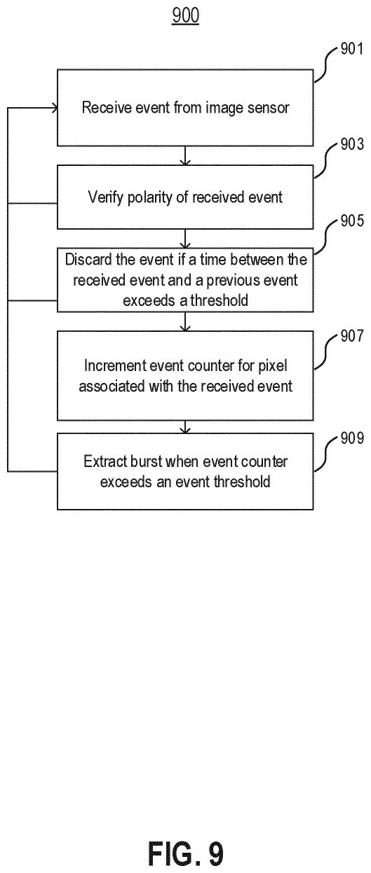

In some embodiments, rather than using single events as depicted in example 800 or timings between single events as depicted in example 850, embodiments of the present disclosure may encode symbols using event bursts. For example, FIG. 9 depicts an example method 900 for detecting event bursts using the image sensor, e.g., image sensor 200 of FIG. 2A, image sensor 250 of FIG. 2B, or the like.

FIG. 9 is a flowchart of an exemplary method 900 for detecting event bursts, consistent with embodiments of the present disclosure. Method 900 of FIG. 9 may be performed using at least one processor, whether integrated as a microprocessor on the same chip as an image sensor (e.g., image sensor 200 of FIG. 2A, image sensor 250 of FIG. 2B, or the like) or provided separately as part of a processing system. The at least one processor may be in electrical communication with the image sensor for purposes of sending and receiving signals, as further disclosed herein.

At step 901, the at least one processor may receive an event from an image sensor (e.g., image sensor 200 of FIG. 2A, image sensor 250 of FIG. 2B, or the like). As described above with respect to step 505 of method 500, the event may comprise a signal from an event-based image sensor or an event extracted from signals of a continuous image sensor (e.g., using a clock circuit).

At step 903, the at least one processor may verify the polarity of the event. For example, the at least one processor may determine whether the polarity matches a polarity expected for the event, whether the same as a previous event if a plurality of increases or decreases is expected or different than the previous event if a polarity change is expected. For example, the projected patterns may be configured to generate a plurality (such as 2, 3, or the like) of events in order to signal an increasing signal or a decreasing signal. Such a plurality may allow for filtering of noise at step 903. If the polarity is not valid, the at least one processor may discard the event and start over at step 901 with a new event, as depicted in FIG. 9. Additionally, or alternatively, if the polarity is not valid, the at least one processor may discard a current burst and use the event from step 901 as the beginning of a new potential burst.

At step 905, the at least one processor may discard the received event if too remote in time from a previous event (e.g., if a difference in time exceeds a threshold). Accordingly, the at least one processor may avoid connecting events too remote in time to form part of a single burst. If the event is too remote, the at least one processor may discard the event and start over at step 901 with a new event, as depicted in FIG. 9. Additionally, or alternatively, if the event is too remote, the at least one processor may discard a current burst and use the event from step 901 as the beginning of a new potential burst.

At step 907, the at least one processor may increment an event counter of an associated pixel. For example, the associated pixel may comprise the pixel from which the event of step 901 was received. The event counter may comprise an integer counting events received at recursive executions of step 901 that qualify, under steps 903 and 905, as within the same burst.

At step 909, the at least one processor may extract a burst when the event counter exceeds an event threshold. For example, the event threshold may comprise between 2 and 10 events. In other embodiments, a greater event threshold may be used. If the burst is extracted, the at least one processor may reset the event counter. If the event counter does not exceed the event threshold, the at least one processor may return to step 901 without resetting the event counter. Accordingly, additional events that qualify, under steps 903 and 905, as within the same burst, may be detected and added to the event counter at step 907.

In some embodiments, method 900 may further include discarding the received event if too remote in time from a first event of a current burst. Accordingly, method 900 may prevent noise from causing a burst to be inadvertently extended beyond a threshold.

Additionally, or alternatively, method 900 may track a number of events by region such that bursts are detected only within regions rather than across a single pixel or the whole image sensor. Accordingly, method 900 may allow for detection of concurrent bursts on different portions of an image sensor.

Whenever an event is discarded, the at least one processor may reset the event counter. Alternatively, in some embodiments, the at least one processor may store the corresponding event counter even when an event is discarded. Some embodiments may use a combination of saving and discarding. For example, the event counter may be saved if an event is discarded at step 903 but may be reset if an event is discarded at step 905.

A detailed description of exemplary embodiments of method 900 is described in International Patent Application No. PCT/EP2019/051919, filed on Jan. 30, 2019, and titled “Method and Apparatus of Processing a Signal from an Event-Based Sensor.” The disclosure of this application is incorporated herein by reference.

Extracted bursts from method 900 may comprise a symbol (e.g., used as part of an encoded pattern). For example, by using a burst to encode a symbol rather than a single event, the system may increase accuracy and reduce noise. Additionally, or alternatively, extracted bursts from method 900 may comprise a set of symbols forming the encoded pattern. For example, by using a burst to encode the pattern, the system may distinguish between distinct patterns in time with greater accuracy and reduced noise.

Although described using the architectures of FIG. 2A or 2B, any image sensor adapted to capturing signals based on brightness of light impinging on one or more photosensitive elements (e.g., photodiodes) may be used. Accordingly, any combination of transistors, capacitors, switches, and/or other circuit components arranged to perform such capture may be used in the systems of the present disclosure. Moreover, the systems of the present disclosure may use any synchronous image sensors (such as image sensor 200 of FIG. 2A) or any event-based image sensors (such as image sensor 250 of FIG. 2B).

While certain embodiments have been described with reference to calculating the three-dimensional rays and three-dimensional image points, systems consistent with the present disclosure may perform other operations and/or be used in other applications. For example, in some embodiments, positions of the pixels where the reflections are extracted may be used to reconstruct a three-dimensional scene or detect a three-dimensional object (such as a person or another object). In such embodiments, the pixel positions may correspond to the three-dimensional positions as a result of the calibration of the system.

Embodiments of the present disclosure may compute three-dimensional points without having to perform triangulation operations by, for example, using a look-up table or machine learning. In some embodiments, a stored look-up table may be used by at least one processor to determine a three-dimensional point from an identified line on a specific pixel position i, j. Additionally, or alternatively, machine learning may be used to determine three-dimensional points from pixel positions for a calibrated system.

In still further embodiments, pixel differences may be used for analysis purposes. For example, assume a disparity (“d”) refers to a pixel difference between where a projected line is observed on the sensor (“x”) and where it is emitted from as an equivalent pixel on the projector (“x_L”), expressed as d=x−x_L. In some embodiments, positions “x” might even directly be used without the direct knowledge of “x_L” in applications where it could, for instance, be extracted through machine learning. In such applications, the three-dimensional points may be computed from the “x” pixel coordinates and the associated disparity to segment background from foreground. For example, the at least one processor may threshold disparity measurements without reconstructing depth (e.g., d<=threshold would be background while d>=threshold would be foreground). In automotive or surveillance applications, for example, it may be desirable to remove points from the ground versus points on objects. As further examples, face, object, and/or gesture recognition could directly receive and be performed from the disparities.

Estimating depth of an object or in a region of interest (ROI) of the sensor could be done after integration (like averaging) of disparities inside an object bounding box or the ROI. Further, in some embodiments, simultaneous landscaping and mapping (SLAM) applications using inverse depth models could use disparity as a proportional replacement.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

In addition to the above-referenced patents and applications, the entirety of each of the following applications are hereby incorporated by reference herein: U.S. Application No. 62/809,557, filed Feb. 22, 2019, titled Systems and Methods for Three-Dimensional Imaging and Sensing; U.S. Application No. 62/810,926, filed Feb. 26, 2019, titled Systems and Methods for Three-Dimensional Imaging and Sensing; and U.S. Application No. 62/965,149, filed Jan. 23, 2020, titled Systems and Methods for Three-Dimensional Imaging and Sensing.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as examples only, with a true scope and spirit of the disclosed embodiments being indicated by the following claims.

1. A system for detecting three-dimensional images, comprising:
a projector configured to project a plurality of lines comprising electromagnetic pulses onto a scene; and
an image sensor comprising a plurality of pixels and configured to detect reflections in the scene caused by the projected plurality of lines, the system further comprising:
at least one processor configured to:
detect one or more first events from the image sensor based on the detected reflections and corresponding to one or more first pixels of the image sensor,
detect one or more second events from the image sensor based on the detected reflections and corresponding to one or more second pixels of the image sensor,
identify a projected line corresponding to the one or more second events and the one or more first events, and
calculate three-dimensional image points based on the identified line.

2. The system of claim 1, wherein the at least one processor is further configured to calculate three-dimensional rays for the one or more first pixels and the one or more second pixels based on the identified line, and calculate the three-dimensional image points based on the three-dimensional rays and a plane equation associated with the identified line.

3. The system of claim 1, wherein the at least one processor is further configured to determine a plurality of patterns associated with the plurality of lines, and wherein the one or more first events correspond to a start of the plurality of patterns associated with the plurality of lines.

4. The system of claim 1, wherein the projector is configured to project one or more dots of each line simultaneously or sequentially.

5. The system of claim 1, wherein the plurality of patterns comprise one of:
at least two different pulse lengths separated by a length of time;
a plurality of pulses separated by different lengths of time; or
pulses having at least one of selected frequencies, phase shifts, or duty cycles used to encode symbols.

6. The system of claim 1, wherein the projector is configured to project the plurality of lines to a plurality of spatial locations in the scene.

7. The system of claim 1, wherein the projector is configured to project one or more dots of the plurality of lines at a plurality of different projection times.

8. The system of claim 1, wherein each pixel of the image sensor comprises:
a detector electrically connected to at least one first photosensitive element and configured to generate a trigger signal when an analog signal matches a condition, wherein the analog signal is a function of brightness of light impinging on the at least one first photosensitive element.

9. The system of claim 8, further comprising at least one second photosensitive element configured to output a signal in response to the trigger signal, wherein the outputted signal is a function of brightness of light impinging on the at least one second photosensitive element.

10. The system of claim 2, wherein the at least one processor is further configured to:
determine the plane equation, wherein a pattern of the plurality of patterns is represented by the one or more first events and the one or more second events based on the plane equation;
determine a plurality of plane equations associated with the plurality of lines and select the line associated with the one or more first events and the one or more second events to determine the associated plane equation of the plurality of plane equations; or
calculate the three-dimensional image points based on an intersection of the plurality of rays and the associated plane equation.

11. The system of claim 1, whether the at least one processor is further configured to:
initialize one or more state machines based on the one or more first events, and store finalized state machines comprising the one or more initialized state machines and candidates for connecting the one or more first events to the one or more second events.

12. The system of claim 1, wherein, to detect the one or more first events, the at least one processor is further configured to perform one of:
receiving one or more first signals from the image sensor and detect the one or more first events based on the one or more first signals, or
receiving one or more first signals from the image sensor, wherein the one or more first signals encode the one or more first events.

13. The system of claim 1, wherein the plurality of lines comprises at least one of geometric lines, curved lines, or dotted lines or a plurality of dots with varying intensity.

14. The system of claim 1, wherein the at least one processor is further configured to:
encode a plurality of symbols into a plurality of patterns associated with the plurality of lines, the plurality of symbols relating to at least one spatial property of the plurality of lines,
command the projector to project the plurality of patterns onto the scene,
based on the one or more first events, initialize one or more state machines,
determine one or more candidates for connecting the one or more second events to the one or more first events,
using the one or more candidates and the one or more state machines, decode the one or more first events and the one or more second events to obtain the at least one spatial property, and
calculate three-dimensional image points for the one or more first pixels and the one or more second pixels based on locations of the one or more first events and the one or more second events on the sensor and the at least one spatial property.

15. An imaging system, comprising:
a plurality of pixels, each pixel comprising:
a first photosensitive element, and
a system for detecting three-dimensional images, the imaging system further comprising:
a projector configured to project a plurality of lines comprising electromagnetic pulses onto a scene;
an image sensor comprising a plurality of pixels and configured to detect reflections in the scene caused by the projected plurality of lines; and
at least one processor configured to:
detect one or more first events from the image sensor based on the detected reflections and corresponding to one or more first pixels of the image sensor,
detect one or more second events from the image sensor based on the detected reflections and corresponding to one or more second pixels of the image sensor,
identify a projected line corresponding to the one or more second events and the one or more first events, and
calculate three-dimensional image points based on the identified line.

16. The imaging system of claim 15, wherein the at least one processor is further configured to determine a plurality of patterns associated with a plurality of lines comprising electromagnetic pulses projected onto the scene, and wherein to determine the plurality of patterns the at least one processor is configured to receive digital signals defining amplitudes separated by time intervals.

17. The imaging system of claim 16, wherein the digital signals defining the amplitudes separated by the time intervals are received from a controller associated with a projector configured to project a plurality of electromagnetic pulses according to the plurality of patterns or the digital signals defining the amplitudes separated by the time intervals are retrieved from at least one non-transitory memory storing the plurality of patterns.

18. The imaging system of claim 15, wherein the first photosensitive element comprises one or more second photosensitive elements.

19. The imaging system of claim 15, further comprising one or more second photosensitive elements configured to output a signal that is a function of brightness of light impinging on the one or more second photosensitive elements.

20. A method for detecting three-dimensional images, comprising:
determining a plurality of patterns corresponding to a plurality of lines comprising electromagnetic pulses emitted by a projector onto a scene;
detecting, from an image sensor, one or more first events based on reflections caused by the plurality of electromagnetic pulses and corresponding to one or more first pixels of the image sensor;
detecting, from the image sensor, one or more second events based on the reflections and corresponding to one or more second pixels of the image sensor;
identifying a projected line corresponding to the one or more second events and the one or more first events;
calculating three-dimensional rays for the one or more first pixels and the one or more second pixels based on the identified line; and
calculating three-dimensional image points for the one or more first pixels and the one or more second pixels based on the three-dimensional rays and a plane equation associated with one of the plurality of lines corresponding to the identified line.

21. The system of claim 3, wherein the one or more second events correspond to an end of the plurality of patterns associated with the plurality of lines.

22. The system of claim 6, wherein at least one of the plurality of spatial locations corresponds to first pattern, and at least one other of the plurality of spatial locations corresponds to a second pattern.

23. The system of claim 7, wherein at least one of the projection times corresponds to at least one of the one or more first events, and at least one other of the projection times corresponds to at least one of the one or more second events.

24. The system of claim 9, wherein the at least one first photosensitive element comprises the at least one second photosensitive element, or
wherein the at least one processor is further configured to receive one or more first signals from at least one of the first photosensitive element and the second photosensitive element.

25. The system of claim 24, wherein the one or more first signals have positive polarity when the condition is an increasing condition and negative polarity when the condition is a decreasing condition.

26. The system of claim 25, wherein the at least one processor is further configured to perform at least one of:
decoding polarities of the one or more first signals to obtain the one or more first events, or
discarding any of the one or more first signals separated by an amount of time larger than a threshold or any of the one or more first signals associated with an optical bandwidth not within a predetermined range.

27. The system of claim 10, wherein the plurality of rays originates from the sensor and represent a set of three-dimensional points in the scene that correspond to the one or more first pixels and the one or more second pixels.

28. The system of claim 11, wherein the at least one processor is further configured to use the stored finalized state machines in determining the candidates for subsequent events, and wherein determining the candidates for connecting the one or more second events to the one or more first events uses the plurality of patterns and the one or more of the stored finalized state machines.

29. The system of claim 11, wherein the one or more second events are timestamped after the one or more first events such that the candidates connect the one or more first events to the one or more second events temporally.

30. The imaging system of claim 19, wherein the first photosensitive element comprises the one or more second photosensitive elements.
